(19) United States
(12) Patent Application Publication
(10) Pub. No.: US 2017/0116238 A1
(43) Pub. Date: Apr. 27, 2017

(54) SYSTEM AND METHOD FOR DETERMINING COMMON SUBSEQUENCES

(71) Applicant: INTELLIRESPONSE SYSTEMS INC., Toronto (CA)

(72) Inventors: CHAD TERNENT, Kitchener (CA); DARREN REDFERN, Stratford (CA)

(21) Appl. No.: 14/923,030

(22) Filed: Oct. 26, 2015

(51) Int. Cl. G06F 17/30

(52) U.S. Cl. CPC G06F 17/30321; G06F 17/30377

(57) ABSTRACT

A computer-implemented method and system of generating a list of substrings that are common to at least two strings in a plurality of strings is disclosed. Each of the plurality of strings comprises a sequence of terms, and each of the substrings comprises a sequence of one or more of these terms. The method includes forming a reverse index of the terms in the plurality of strings. The reverse index identifies, for each of the terms, the one or more strings containing that term and position therein. The method includes arranging the plurality of strings in an order; and for each one of the strings in the order determining, using the reverse index, substrings common to that one of the strings and subsequent ones of the strings in the order; and for each one of those common substrings, saving an indication associating that common substring with the one of the strings and the subsequent ones of the strings in which that substring is found.

### TECHNICAL FIELD

This relates to data processing, and more particularly, to determining common subsequences of two or more strings.

### BACKGROUND

In many fields of study, it may be necessary to determine subsequences common to sequences of numbers, words, characters, proteins, etc. In some cases, it may be especially desirable to determine the longest subsequence common to some or all of the subsequences being considered.

Such sequences to be analyzed may be represented in a computer as a string—a sequence of terms—each term of the string representing an element of the sequence. These strings may then be analyzed and compared by the computer in order to determine common substrings.

Common approaches to processing strings to determine common subsequences employ dynamic programming. The algorithms employed in such approaches may use substantial computing resources or take a long time when the strings to be processed encompass a large amount of data.

### SUMMARY

In one aspect, there is provided a computer-implemented method of generating a list of substrings that are common to at least two strings in a plurality of strings, wherein each of the plurality of strings comprises a sequence of terms, and wherein each of the substrings comprises a sequence of one or more of the terms, the method comprising: forming a reverse index of the terms in the plurality of strings, the reverse index identifying, for each of the terms, the one or more strings containing that term and position therein; arranging the plurality of strings in an order; and for each one of the strings in the order: determining, using the reverse index, substrings common to the one of the strings and subsequent ones of the strings in the order; and for each one of those common substrings, saving an indication associating that common substring with the one of the strings and the subsequent ones of the strings in which that substring is found.

In another aspect, there is provided a computer system for generating a list of substrings that are common to at least two strings in a plurality of strings, the system comprising: at least one processor; a memory in communication with the at least one processor; instructions stored in the memory that, when executed by the at least one processor, cause the computer system to: form a reverse index of the terms in the plurality of strings, the reverse index identifying, for each of the terms, the one or more strings containing that term and position therein; arrange the plurality of strings in an order; and for each one of the strings in the order: determine, using the reverse index, substrings common to the one of the strings and subsequent ones of the strings in the order; and for each one of those common substrings, save an indication associating that common substring with the one of the strings and the subsequent one of the strings in which that substring is found.

In yet another aspect, there is provided a non-transitory computer readable storage medium storing instructions that, when executed, adapt a computer to: form a reverse index of the terms in the plurality of strings, the reverse index identifying, for each of the terms, the one or more strings containing that term and position therein; arrange the plurality of strings in an order; and for each one of the strings in the order: determine, using the reverse index, substrings common to the one of the strings and subsequent ones of the strings in the order; and for each one of those common substrings, save an indication associating that common substring with the one of the strings and the subsequent one of the strings in which that substring is found.

### BRIEF DESCRIPTION OF THE DRAWINGS

Embodiments are described in detail below, with reference to the following drawings.

FIG. 1 is a high level block diagram of a computing device, exemplary of an embodiment;

FIG. 2 illustrates the software organization of the computer of FIG. 1;

FIG. 3 is a flowchart depicting example blocks performed by the string processing software of FIG. 2;

FIG. 4 illustrates a representation of a reverse index, exemplary of an embodiment, for an example set of strings;

FIG. 5 is a further flowchart depicting example blocks performed by the string processing software of FIG. 2; and

FIGS. 6A and 6B illustrate a source code listing depicting pseudo-code exemplary of an embodiment.

### DETAILED DESCRIPTION

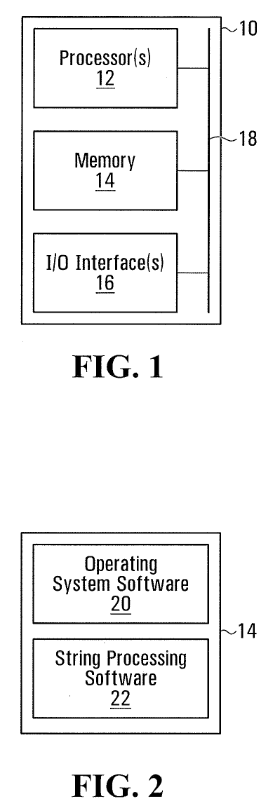

FIG. 1 is a high level block diagram of a computing device, exemplary of an embodiment. As will become apparent, the computing device includes software that analyzes two or more strings to determine longest common substrings.

As illustrated, the computing device 10 includes one or more processors 12, a memory 14, and one or more I/O interfaces 16 in communication over bus 18.

One or more processors 12 may be one or more Intel x86, Intel x64, AMD x86-64, PowerPC, ARM processors or the like.

Memory 14 may include random-access memory, read-only memory, or persistent storage such as a hard disk, a solid-state drive or the like. Read-only memory or persistent storage is a computer-readable medium. A computer-readable medium may be organized using a file system, controlled and administered by an operating system governing overall operation of the computing device.

One or more I/O interfaces 16 may serve to interconnect the computing device with peripheral devices, such as for example, keyboards, mice, and the like. One or more I/O interfaces 16 may also comprise communication devices such as, for example network controllers, modems, and the like that may serve to interconnect the computing device with one or more computer networks such as, for example, a local area network (LAN) or the Internet.

Software comprising instructions is executed by one or more processors 12 from a computer-readable medium. For example, software may be loaded into random-access memory from persistent storage of memory 14 or from one or more devices via I/O interfaces 16 for execution by one or more processors 12. As another example, software may be loaded and executed by one or more processors 12 directly from read-only memory.

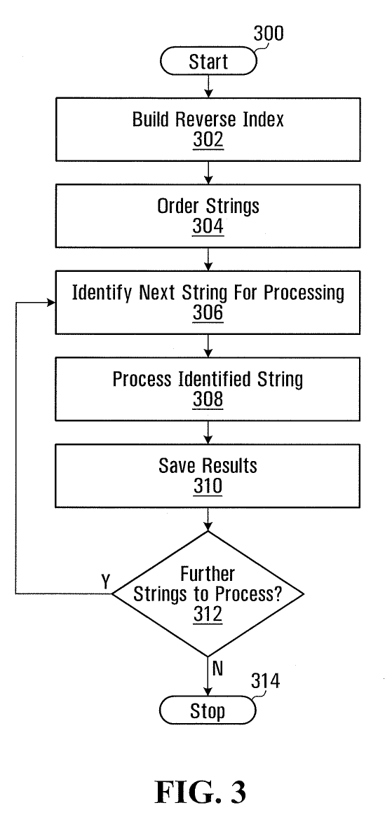

FIG. 2 depicts a simplified organization of example software components stored within memory 14 of computing device 10. As illustrated these software components include operating system (OS) software 20, and string processing software 22.

OS software 20 may be, for example, Microsoft Windows, UNIX, Linux, Mac OSX, or the like. OS software 20 allows string processing software 22 to access one or more processors 12, memory 14, and one or more I/O interfaces 16 of the computing device.

String processing software 22 adapts computing device 10, in combination with OS software 20, to operate as a device for determining substrings common to at least two strings in a plurality of strings, exemplary of embodiments.

String processing software 22 is executed by one or more processors 12 so as to process a plurality of strings to generate a list of substrings common to at least two strings of the plurality. Each of the strings and substrings comprises a sequence of one or more terms. The terms may, or may be individually delimited. The contents of the strings may represent anything that can be represented as an ordered sequence.

For example, input may be supplied as two sequences of terms (each term in the string consisting of a single character and optionally separated from adjacent terms by a space): “A B D B C A D” and “B A B B A”. A subsequence, is any sequence of terms contained within another sequence—up to including the entire sequence. For example, “A” “A B”, “A B D”, “A B D B”, “A B D B C”, “A B D B C A”, “A B D B C A D”, “B”, “BD”, “B D B”, “B D B C”, “B D B C A”, “B D B C A D”, “D”, “D B”, “D B C”, “D B C A”, “D B C A D”, “B”, “B C”, “B C A”, “B C A D”, C”, “C A”, “C A D” are all subsequences of the sequence “A B D B C A D”. The common subsequences of “A B D B C A D” and “B A B B A” would be “A”, “A B”, and “B”.

Each term may be made up of one or more characters in some character set such as, for example, Unicode, ASCII, or EBCDIC. Within the string, the terms may be delimited by particular characters. For example, terms may be separated by a space character or a comma. As an example, a string could be a query string comprising one or more words, each word a sequence of one or more characters, the words separated by spaces.

Alternatively, each term may have a pre-defined size—e.g. a single character; two characters; or the like.

Alternatively, terms may represent non-character data such as numbers. Numbers may be integers represented by various encodings such as binary coded decimal, ones-complement, twos-complement, or fixed point. Numbers may also be floating point numbers represented by some arithmetic format such as those set out the various IEEE floating point standards and the like.

In yet another alternative, terms may represent specialized data such as proteins.

Strings may have been previously stored in memory 14. For example, the terms of each string may be stored contiguously in memory in the format to be processed. As another example, the terms of each string may be stored in various data structures, such as for example a compressed form, from which the sequence of terms comprising a string may be reconstructed by appropriate processing. As yet another example, the strings may be received using one or more I/O interfaces 16 and processed in a streaming fashion as received either without or without intermediate buffering so as to, for example, memory 14.

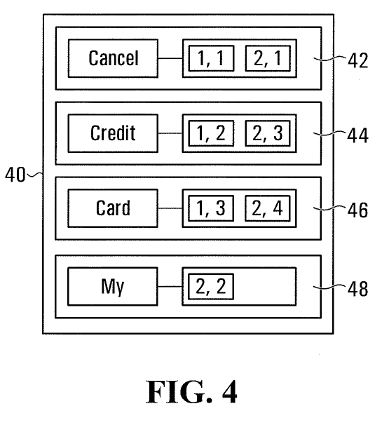

The operation of the string processing software is further described with reference to the flowchart of FIG. 3. Blocks S300 and onward are performed by one or more processors 12 executing string processing software 22 at computing device 10.

At block 302, one or more processors 12 form a data structure known as a reverse index according to string processing software 22. An inverted index is a data structure known to persons skilled in natural language processing. Same or similar data structures may also be referred to variously as an “inverted index” or a “positional postings list”. Fundamental to any such a data structure is that it identifies, for each term found in any of one or more strings, the one or more strings containing that term and the position of the term in each string.

Reverse indexes may be generated according to standard methods known to skilled persons. According to such methods, a single reverse index may be generated for the entire body of input; that is, all strings of the plurality of strings. Additionally or alternatively, more than one reverse index may be generated for a given set of string, each index considering some subset of the set of strings such that, for example, all strings are considered in a least one reverse index. As will become apparent, one or more processors 12 consult reverse indexes in executing string processing software 22. Where there is more than one reverse index, one or more processors 12 may consult one or more of the more than one reverse indexes during processing such as according to the strings being compared at a given step.

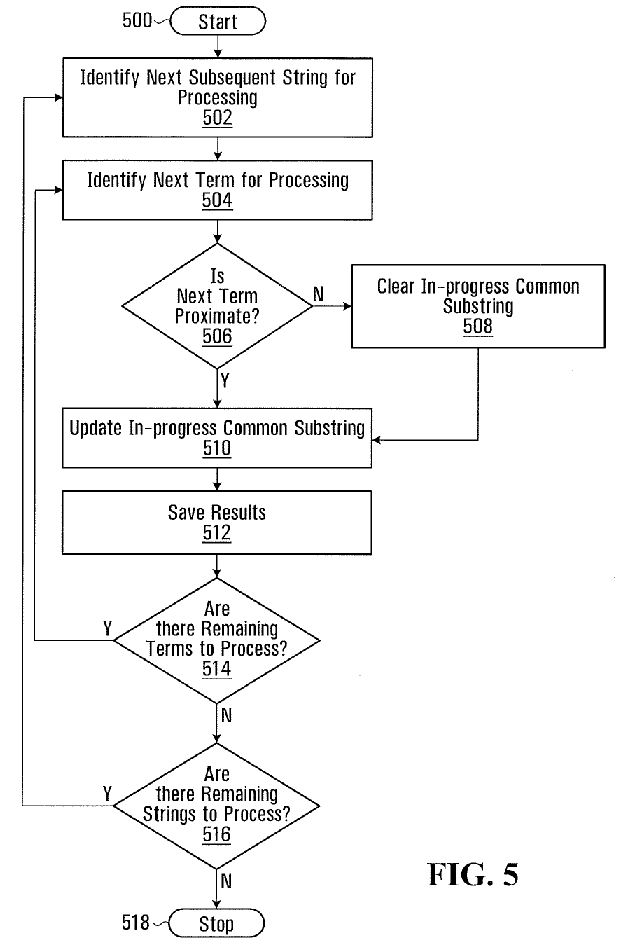

FIG. 4 illustrates a representation of an example reverse index for an example set of strings. Reverse index 40 as illustrated is constructed over two example strings: a first string, “cancel credit card” and a second string, “cancel my credit card”. There are four entries illustrated in the example the reverse index, entry 42, entry 44, entry 46, and entry 48.

Entry 42 shows that the term “credit” is found in the first string at a position of offset 2 and in the second string at a position of offset 3.

Entry 48 shows that the term “my” is found only in the second string at position of offset 2. The absence of an entry corresponding to the first string implies that the term is not found in that string.

Reverse indexes may be represented in memory 12 in various formats such as, for example, in an array, a linked list, a hash table, or some combination thereof. For example, an array could be maintained with an element corresponding to each term in a set of strings, with the element pointing to a linked list of records, each record indicating the various strings in which that term occurs and its position therein. Alternatively, for example, a multidimensional array could be maintained with each row of the multidimensional corresponding to a term in a set of strings, and each column corresponding to a string in the set of strings. Then, each element could be set either to the position of that term in that string. If the term does not occur in that string, an indication of this could instead be stored in the element such as by, for example, storing a sentinel value, such as, for example, the maximum integer, in that element.

The representation of a reverse index in memory may also vary in other ways. For example, the indication of a particular string in a reverse index may have some other format such as, for example, a pointer to a memory location or an index into some other a data structure.

The offset into a string in a reverse index may have some other representation. As an example, rather than the first location in a string being represented as offset 0, it may be represented as offset 1. As another example, offsets may count right-to-left rather than the left-to-right counting illustrated in FIG. 4.

The indication of a particular string and the offset therein may be combined in some reverse indexes such as by providing, for example, a pointer to a memory location falling within the in-memory representation of the string or an index into some other data structure.

Various representations of a reverse index may offer trade-offs between computing resources consumed for construction and/or consultation of the reverse index such as, for example, requiring more or fewer instructions to be executed or more or fewer accesses to memory be performed and the storage resources consumed by the representation such as, for example, the use or more of less memory. Additionally or alternatively, various representations may have greater or lesser performance according to considerations such as, for example, the performance of a cache (not illustrated) of one or more processors 12. In some embodiments, analysis of performance of a representation of a reverse index may be performed according to techniques known to skilled persons, such as, for example, profiling.

Returning to consideration of FIG. 3, at block 304, the strings of the plurality of strings are arranged in an order. Arranging of the strings of the plurality of strings in an order may or may not entail actual processing of the strings. For example, the strings may be processed and placed into an ordered data structure. As another example, the strings may be processed and their ordering noted in a data structure that contains some indication, such as a pointer, of the string in each position. As yet another example, the strings may already have some natural order due to the nature of their storage or the order in which they are being received.

In some embodiments, block 304 may not entail substantive data processing. For example, where strings are being processed as received in a streaming fashion, the ordering may simply be the order in which strings are received.

Optionally, strings may be filtered before arranging them in an order such that, for example, only a subset of the plurality of strings may feature in the order.

At block 306, one or more processors 12 identify the next string in the order for processing. Strings may be processed starting with the first string in the order and ending with the last string in the order. Alternatively, strings may be processed starting with some other string in the order. Optionally, only a subset of the strings in the order may be identified for processing, such as according to, for example, filtering criteria as may be applied in identifying the next string such that, for example, only strings meeting that criteria are identified for processing with other strings in the order being discarded.

At block 308, the string identified at block 306 is processed relative to the subsequent strings in the order to ascertain, using the reverse index, substrings common to the identified string and subsequent strings in the order. Each common substring so identified is common to at least a string pair comprising the identified string and a subsequent string in the order. In some cases, a substring may be common to more than one such pair.

At block 310, indications are saved associating identified common substrings with the string identified at block 306 and with the subsequent string with which each substring is common as identified at block 308.

Indications associating a common substring with a string may be, for example, maintained by way of a plurality of lists, each list associated with a string of the plurality of strings. For example, saving an indication associating a common substring with the string identified at block 306 and a subsequent string to which it is common may comprise inserting an element indicating the common substring into the list associated the string identified at block 306 and into the list associated with the subsequent string to which it is common as identified at block 308.

Additionally or alternatively, the element inserted into such a list may comprise a hash of the common substring. Then, on subsequent insertions into the list the hash of the item being inserted may be compared to the hashes within elements of the list, with a new element inserted only if no matching hash is found. If a matching hash is found, the element may be maintained by, for example, increasing an instance count. Alternatively, if a matching hash is found, the list may be left undisturbed. In this way, the list may be maintained as a set. Conveniently, in either case, a suitable checksum may be used in lieu of a hash to similar effect.

Additionally or alternatively, the element being inserted into such a list may comprise the actual common substring.

Additionally or alternatively, the element being inserted may comprise a length and an offset into the string with which the list is associated according to which the common substring may be located within that string.

Additionally or alternatively, the element being inserted into such a list may comprise a pointer to the other string with which the common substring is common. Then, the element being inserted may comprise a length and an offset into the other string using which the common substring may be located within that string. Alternatively, the pointer may point at a memory location offset from the start of the other string so as incorporate the offset into the pointer.

At block 312, one or more processors 12 determine whether or not strings in the order remain to be processed. For example, if the last string in the order was previously identified for processing at block 306, processing may be complete. If strings in the order remain to be processed, control flow returns to block 306.

Conveniently, as described with reference to FIG. 3, each pair of strings is only considered once. This is possible because the method takes advantage of the fact that the determining of the common substrings of a first string and a second string is commutative. Additionally, by the definition of the problem, no string need be compared to itself. Thus, string processing software 22 may, according to FIG. 3, exploit these properties to lessen the overall number of string pairs that must be considered to be less than the cardinality of the cross-product of the ordering with itself as might otherwise be considered in a more naïve procedure. Conveniently, in this way, one or more processors 12 executing string processor software 22 may require fewer computations to determine substrings common to at least two strings of a plurality of strings as compared to more naïve procedures.

Optionally, string processing software 22 may embody additional functionality by way of instructions that when executed by one or more processors 12 cause additional processing.

For example, one or more processors 12 may, according to string processing software 22, identify a longest of the common substrings associated with each string of the plurality. As a specific example, for the two example strings above, a longest common substring “A B” of each of the two strings may be identified. In some embodiments, only such a longest common substring may be identified for each pairing.

In such an example, each identification associating a common substring with a string may be processed to determine which of the associated common substrings is the longest. Additionally or alternatively, an indication associated with a string may be maintained during the processing to track the longest common substring identified thus far for that string. In alternate embodiments, no indications may be saved at block 308, and saving may comprise instead, for one or more strings, only maintenance of such a longest common substring indication for that string.

As another example, one or more processors 12 may, according to string processing software 22, identify, for a term found in a string of the plurality of strings, a longest of the common substrings associated with that string as contains that term. As a specific example, for the two example strings above, a longest common substring of the first string containing term “A” is “A B”.

As yet another example, a weight may be associated with the terms occurring in the strings of the plurality of strings. For example, for some terms—such as, for example, terms as may be identified as “stop words” for the purposes of particular processing such as, for example, “a” or “the”—a weight may be associated with those terms. For example, the weight associated with one or more of such terms could be fractional or even zero. Alternatively, there may be a preprocessing step in which one or more of the strings of the plurality of strings are processed to determine a weight between zero and one associated with any or all of the one or more terms of the strings.

Additionally or alternatively, a weight may be associated with each common substring. For example, where there is a weight associated with terms, a weight may be associated with each common substring. For example, that weight may e set equal to the sum of the weights associated with the terms of that substring. One or more processors 12 may perform further processing according to the weight associated with a substring. For example, for one or more strings of the plurality of strings, a highest weighted of the common substrings associated with that string may be identified such as by way of, for example, maintaining of indications of weights associated with one or more substrings during processing. Additionally or alternatively, where a weight is associated with each common substring, one or more processors 12 may identify, for one or more terms as found in a string of the plurality of strings, the highest weighted common substring associated with that string as contains that term.

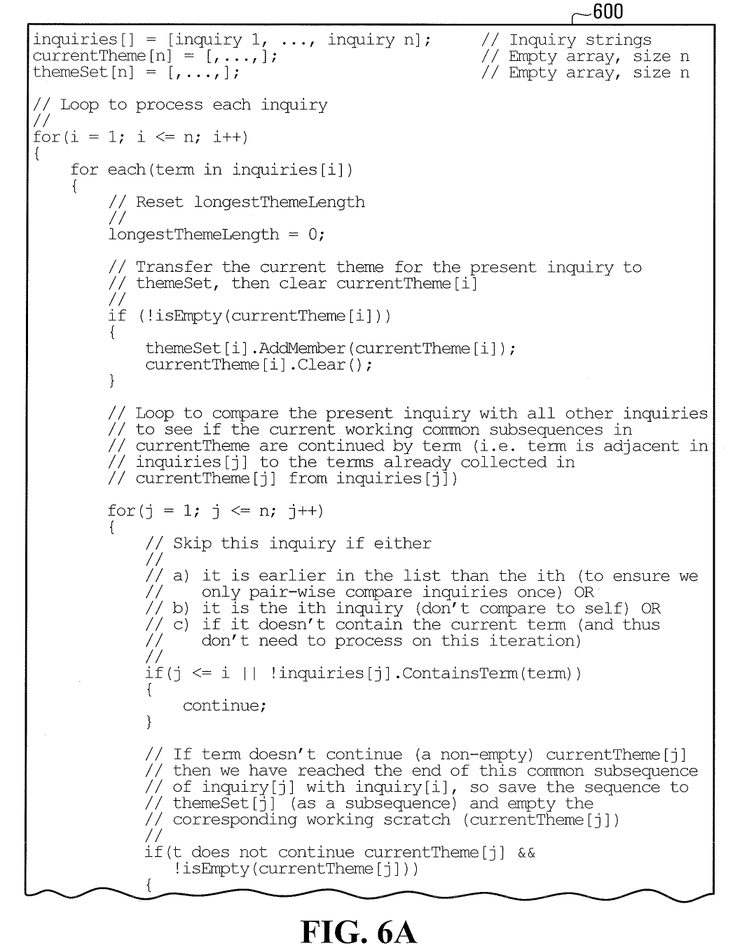

FIG. 5 is a flowchart depicting example blocks 500 and onward as may be performed by one or more processors 12, such as according to processing software 22, in performing block 308 of FIG. 3.

At block 502, a next string of the strings subsequent to the string identified for processing at block 306 is identified for processing relative to the earlier identified string. For example, subsequent strings may be processed starting with the first string in the order following the string identified at block 306. Alternatively, subsequent strings may be processed in some other order such as, for example, some natural order as may exist according to a data structure storing the strings in memory 14.

A string identified for processing at block 306 is hereinafter, for the purposes of the discussion of FIG. 5, referred to as the first string. A next string identified for processing at block 502 is hereinafter, for the purposes of the discussion of FIG. 5, referred to as the second string.

An in-progress substring is associated with each string of the order. The in-progress substring may be initialized, such as, to the null or empty string.

At block 504, a next term of the terms of the first string is identified for processing. The terms of the first string may be processed starting with a first term in the sequence comprising that string and ending with a last term in the sequence comprising that string. Alternatively, strings may be processed right-to-left, starting with a last term in the sequence comprising that string and ending with a first term in the sequence comprising that string, or alternatively again, in some other order.

At block 506, one or more processors 12 determine whether the next term is proximate to the in-progress substring for the second string in the second string. If so determined, control flow proceeds to block 510 else to block 508.

A term may be considered proximate to an in-progress common substring in the second string, if, for example, the term is adjacent to the in-progress common substring in the second string. In a specific example, if the strings being processed contain terms delimited by spaces and the strings are being processed left-to-right, the term “C” is proximate to an in-progress common substring “A B” for a second string “X A B C D”, whereas terms “X” and “D” is not. In another example, where strings are being processed right-to-left, “X” is proximate to that in-progress common substring in that same second string, whereas “C” and “D” are not. Notably, any term may be considered proximate to a null or empty in-progress substring in a second string provided the term is found in the second string.

As another example, a weight—such as may range, for example, between zero and one substantially as described above—may be associated with each term. Determining whether a term is proximate to an in-progress common substring for the second string in the second string may then comprise determining whether a sum of the weights associated with each of the terms between the in-progress common substring and that term in that subsequent one of the strings is less than a threshold. For example, a term may be considered proximate to an in-progress common substring in a string if a sum of the weights associated with each of the terms between the in-progress common substring and that term in that string is less than one. Such an application of weights may have application, for example, in giving less precedence to, or even ignoring, “stop words” in strings.

The determination of whether a next term is proximate to an in-progress substring for the second string in the second string may be made according to the reverse index. For example, processing at block 506 may include using a reverse index to determine whether the next term occurs in the second string via a lookup of the term in the index. Additionally or alternatively, a position of the term in the second string may be determined by way of such a look-up.

At block 508, the in-progress common substring is cleared and control flow then proceeds to block 510.

At block 510, the in-progress common substring for the second string is updated by appending the next term to that string. The in-progress common substring is also identified as a common substring of the first string and the second string.

At block 512, one or more indications are saved associating the identified common substring with the first string and the second string.

At block 514, one or more processors 12 determine whether or not terms in the first string remain to be processed. For example, if processing is proceeding left-to-right and the last term in the first string was the last identified for processing at block 504, processing of the first string is complete. If processing of the first string is completed, control flow proceeds to block 516, otherwise control flow returns to block 504.

At block 516, one or more processors 12 determine whether or not subsequent strings in the order remain to be processed. For example, if strings in the order are being processed first-to-last and the last string in the order was the last identified for processing at block 502, processing of all subsequent strings is completed. If processing is completed, control flow proceeds to block 518, otherwise control flow returns to block 502.

Reset of in-progress substrings may comprise de-allocation. Additionally or alternatively, reset of an in-progress substring may be flagged such as by, for example, clearing or reset that in-progress substring to a special value such as the null or empty string or to some other sentinel value.

In FIG. 5, as described, processing proceeds in what may be described as “string-major” order, where each possible second string is considered relative to all terms of the first string before another second string is considered. This is, however, merely exemplary.

For example, processing could instead proceed in a “term-major” order where each term of the first string is considered relative to every possible second string before another term is considered. A skilled person will recognize that both orderings may be functionally equivalent where an in-progress substring is maintained for each string of the order. However, in some cases one may be preferable to the other such as, for example, for reasons of improving the performance of a CPU cache of one or more processors 12 or memory 14 such as by, for example, reducing cache misses.

As another example, processing of one or more strings or terms could occur in parallel, such as is, for example, possible when one or more processors 12 comprises two or more processors.

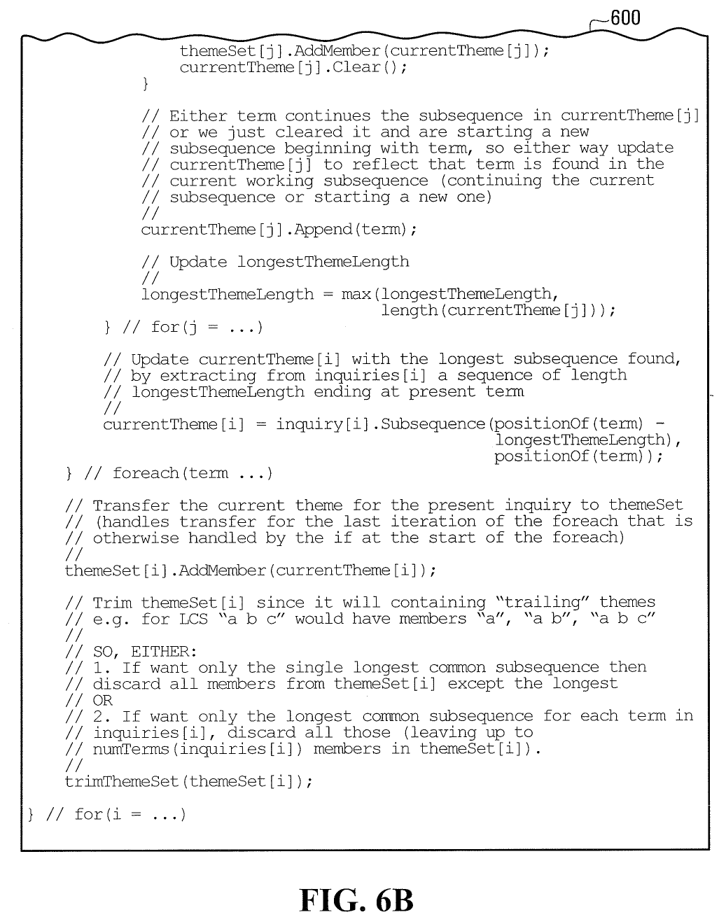

FIGS. 6A and 6B illustrate a source code listing depicting pseudo-code exemplary of an embodiment.

Pseudo-code listing 600 presents a pseudo-code listing in a hypothetical ALGOL-like language with a syntax somewhat similar to C, C++, C#, or Java. Pseudo-code listing 600 is exemplary of an embodiment and is in no way limiting of the invention nor is it exemplary of all embodiments.

Pseudo-code listing 600 may be translated by a skilled-person into a source code listing in any one of a plurality of programming languages and then may be compiled into machine code for execution by one or more processors of one or more computing devices. As an alternative, pseudo-code listing 600 may be translated into a source code listing in a language suitable for processing by a language interpreter executing on one or more computer devices.

The first line of pseudo-code listing 600 declares an array, “inquiries”, that may be initialized by suitable code to a series of input strings, referred to as “inquiry strings” in the listing.

The second line of pseudo-code listing 600 declares an array, “currentTheme”, used to hold in-progress common substrings corresponding the inquiry strings in the array declared at the first line.

The third line of pseudo-code listing 600 declares an array of sets, “themeSet”, each set storing common substrings of a corresponding inquiry string in the array declared at the first line.

Subsequent lines of pseudo-code listing 600 assume the existence of functions for determining whether a particular term is in a string (“ContainsTerm( )”), as well as methods of determining whether a term continues a substring within a string. Each may employ a reverse index in ways substantially similar to those described above.

The problem of efficiently identifying longest common substrings has application in the data processing necessary in numerous fields of endeavour. Conveniently, applying the present invention to such a may use less computing resources than common dynamic programming approaches.

For example, string processing software 22 may be configured to determine the longest non-overlapping subsequences of a plurality of strings.

As another example, string processing software 22 may be employed in the processing of query strings.

As yet another example, common substrings may be used determine common “themes” amongst the plurality of strings. These themes may then be employed in subsequent processing such as to, for example, facilitate grouping or classification of queries.

For example, an exemplary application might compare the two example strings that feature in reverse index 40 as query strings. The longest non-overlapping common substrings of the two example strings may be determined to be “cancel” and “credit card”. Such an exemplary application may then use “cancel” and “credit card” as “themes” in subsequent processing of one or more of the strings. Fractional values may be assigned to some terms in the query strings, such as is substantially described above, so as to giving less precedence to or even ignore “stop words”.

Of course, the above described embodiments are intended to be illustrative only and in no way limiting. The described embodiments are susceptible to many modifications of form, arrangement of parts, details and order of operation. The invention is intended to encompass all such modification within its scope, as defined by the claims.

What is claimed is:

1. A computer-implemented method of generating a list of substrings that are common to at least two strings in a plurality of strings, wherein each of said plurality of strings comprises a sequence of terms, and wherein each of said substrings comprises a sequence of one or more of said terms, said method comprising:
forming a reverse index of said terms in said plurality of strings, said reverse index identifying, for each of said terms, the one or more strings containing that term and position therein;
arranging said plurality of strings in an order; and
for each one of said strings in said order:
determining, using said reverse index, substrings common to said one of said strings and subsequent ones of said strings in said order; and
for each one of those common substrings, saving an indication associating that common substring with said one of said strings and the subsequent ones of said strings in which that substring is found.

2. The method of claim 1, further comprising identifying, for each of said plurality of strings, a longest of the common substrings associated with that string.

3. The method of claim 1, further comprising identifying, for a given term in a given string of said plurality of strings, a longest of the common substrings associated with said given string containing said given term.

4. The method of claim 1, wherein a weight between zero and one is associated with each of said terms.

5. The method of claim 4, wherein a weight is associated with each of said substrings, said weight equal to a sum of the weights associated with the terms of that common substring.

6. The method of claim 5, further comprising identifying, for each of said plurality of strings, a highest weighted of the common substrings associated with that string.

7. The method of claim 6, further comprising identifying, for a given term in a given string of said plurality of strings, a highest weighted of the common substrings associated with said given string containing said given term.

8. The method of claim 1, further comprising maintaining, for each of said plurality of strings, a list, and wherein said saving an indication associating a common substring with one of said strings in said order and a subsequent one of said strings in said order comprises:
inserting into the list for said one of said strings, an element indicating said common substring; and
inserting into the list for said subsequent one of said strings, an element indicating said common substring.

9. The method of claim 8, wherein each of said elements indicating a common substring comprises at least one of a hash of the common substring, a checksum of the common substring, and a structure comprising a pointer to a string of said plurality of strings, an offset indicating the position of a first term of the common substring in said string, and a length of said common substring.

10. The method of claim 1, wherein said determining substrings common to said one of said strings and subsequent ones of said strings in said order comprises:
for each of said subsequent ones of said strings:
maintaining an in-progress common substring; and
for each term in said one of said strings, upon determining that, according to said reverse index, that term is proximate to said in-progress common substring in that subsequent one of said strings:
updating said in-progress common substring by appending that term; and
identifying said in-progress common substring as a common substring of said one of said strings and that subsequent one of said strings.

11. The method of claim 10, wherein said determining that, according to said reverse index, that term is proximate to said in-progress common substring in that subsequent one of said strings comprises determining whether that term is adjacent to said in-progress common substring in that subsequent one of said strings.

12. The method of claim 10, wherein a weight between zero and one is associated with each of said terms, and wherein said determining that, according to said reverse index, that term is proximate to said in-progress common substring in that subsequent one of said strings comprises determining whether a sum of the weights associated with each of the terms between said in-progress common substring and that term in that subsequent one of said strings is less than a threshold.

13. A computer system for generating a list of substrings that are common to at least two strings in a plurality of strings, the system comprising:
at least one processor;
a memory in communication with the at least one processor;
instructions stored in the memory that, when executed by the at least one processor, cause the computer system to:
form a reverse index of said terms in said plurality of strings, said reverse index identifying, for each of said terms, the one or more strings containing that term and position therein;
arrange said plurality of strings in an order; and
for each one of said strings in said order:
determine, using said reverse index, substrings common to said one of said strings and subsequent ones of said strings in said order; and
for each one of those common substrings, save an indication associating that common substring with said one of said strings and the subsequent ones of said strings in which that substring is found.

14. The system of claim 13, wherein said instructions further cause said computer system to identify, for each of said plurality of strings, a longest of the common substrings associated with that string.

15. The system of claim 13, wherein said instructions further cause said computer system to identify, for a given term in a given string of said plurality of strings, a longest of the common substrings associated with said given string containing said given term.

16. The system of claim 13, wherein a weight between zero and one is associated with each of said terms and wherein a weight is associated with each of said substrings, said weight equal to a sum of the weights associated with the terms of that common substring and wherein said instructions further cause said computer system to identify, for each of said plurality of strings, a highest weighted of the common substrings associated with that string.

17. A non-transitory computer readable storage medium storing instructions that, when executed, adapt a computer to:
form a reverse index of said terms in said plurality of strings, said reverse index identifying, for each of said terms, the one or more strings containing that term and position therein;
arrange said plurality of strings in an order; and
for each one of said strings in said order:
determine, using said reverse index, substrings common to said one of said strings and subsequent ones of said strings in said order; and
for each one of those common substrings, save an indication associating that common substring with said one of said strings and the subsequent ones of said strings in which that substring is found.
